(19) United States
(12) Patent Application Publication
(10) Pub. No.: US 2018/0348873 A1
(43) Pub. Date: Dec. 6, 2018

(54) INPUT DEVICE

(71) Applicant: DENSO TEN Limited, Kobe-shi (JP)

(72) Inventor: Hironori SHIROTO, Kobe-shi (JP)

(73) Assignee: DENSO TEN Limited, Kobe-shi (JP)

(21) Appl. No.: 15/924,699

(22) Filed: Mar. 19, 2018

(30) Foreign Application Priority Data
May 31, 2017 (JP) 2017-107870

(51) Int. Cl. G06F 3/01

(52) U.S. Cl. CPC G06F 3/016

(57) ABSTRACT

An input device includes an operation panel, a vibrator, and a support panel. The operation panel has an operation surface and a back surface. The vibrator is mounted on a mounting region of the operation panel at an end portion of the back surface, and vibrates the operation panel. The support panel faces the back surface of the operation panel, and supports the operation panel. The support panel includes a first support panel and a second support panel. The first support panel that, when viewed in a direction orthogonal to the operation surface, overlaps the mounting region of the operation panel on which the vibrator is mounted. The second panel is disposed between the operation panel and the first support panel, and when viewed in the direction orthogonal to the operation surface, does not overlap the mounting region of the operation panel on which the vibrator is mounted.

### BACKGROUND OF THE INVENTION

### Field of the Invention

The present invention relates to an input device and an input system.

Description of the Background Art

In the related art, an input device that allows a riser to recognize acceptance of an input operation by giving a sense of touch to the user has been known. In the input device, for example, vibration is generated in response to a pressure force by the user acting on an operation surface, which allows the user to recognize acceptance of the input operation.

Here, in the input device, a vibrator that vibrates an operation panel having an operation surface is mounted on the back surface of the operation panel. However, on a side of the back surface of the operation panel, a support panel for supporting the operation panel is disposed. For this reason, the vibrator is disposed between the support panel and the operation panel, and depending on a size of the support panel, a wire connected to the vibrator may come into contact with the support panel, for example. Therefore, in the related art, in some cases it is difficult to draw out the wire from the vibrator.

### SUMMARY OF THE INVENTION

According to one aspect of the present invention, there is provided an input device including an operation panel that has an operation surface and a back surface facing in a direction opposite to a direction in which the operation surface faces, a vibrator that is mounted on a mounting region of the operation panel located at an end portion of the back surface of the operation panel and vibrates the operation panel, and a support panel that is disposed to face the back surface of the operation panel and supports the operation panel. The support panel includes a first support panel that, when viewed in a direction orthogonal to the operation surface, overlaps the mounting region of the operation panel on which the vibrator is mounted, and a second support panel that is disposed between the operation panel and the first support panel, and when viewed in the direction orthogonal to the operation surface, does not overlap the mounting region of the operation panel on which the vibrator is mounted.

It is possible to easily draw out the wire from the vibrator mounted on the back surface of the operation panel.

According to another aspect of the present invention, the operation panel is a rectangular plate having opposite long sides and opposite short sides that are shorter than the long sides, the second support panel is a quadrilateral plate, the vibrator is mounted on an end portion of at least one of the opposite short sides of the operation panel, and sides of the second support panel corresponding to the long sides of the operation panel are shorter than the long sides of the operation panel.

The wire can be further easily drawn out from the vibrator.

Therefore, an object of the present invention is to provide an input device and an input system in which a wire can be further easily drawn out from a vibrator mounted on a back surface of an operation panel.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 A is a plan view of an input device according to an embodiment.

FIG. 1B is a cross sectional view taken along line A-A in. FIG. 1A.

FIG. 2 is a view showing an example of mounting of an electronic device system according to the embodiment.

FIG. 3 is a view showing an example of a configuration of the electronic device system according to the embodiment.

FIG. 4 is a plan view of an input system according to the embodiment

FIG. 5 is a cross sectional view taken along line V-V of FIG. 4.

FIG. 6 is a cross sectional view taken along line VI-VI in FIG. 4.

FIG. 7 is a view of a relationship between the input system and a display device.

### DESCRIPTION OF THE EMBODIMENTS

Hereinafter, embodiments of an input device and an input system disclosed in the present invention will be described in detail with reference to accompanying drawings. The present invention is not limited to the embodiments described below.

### 1. Outline of Input Device

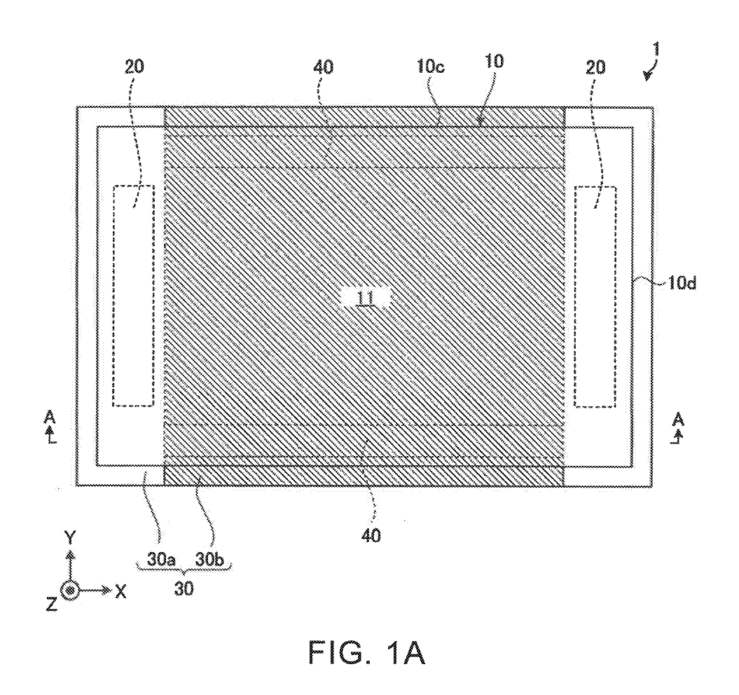

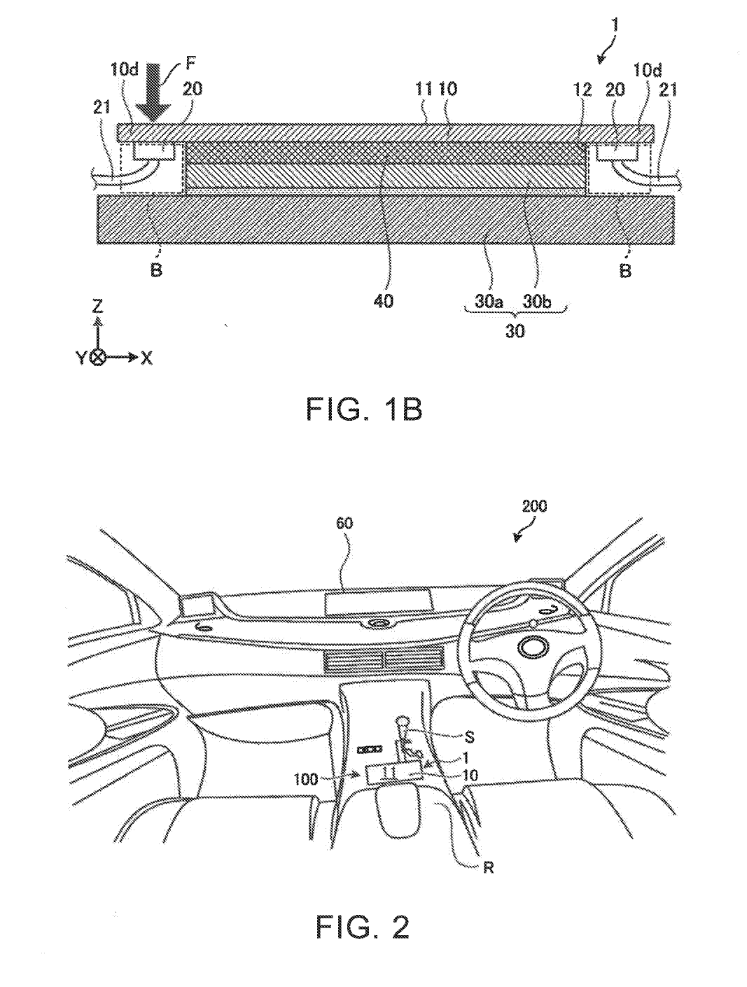

In the following, first, an outline of an input device according to an embodiment will be described using FIG. 1A and FIG. 1B. FIG. 1A is a plan view of an input device according to an embodiment. FIG. 1B is a cross sectional view taken along line A-A in FIG. 1A.

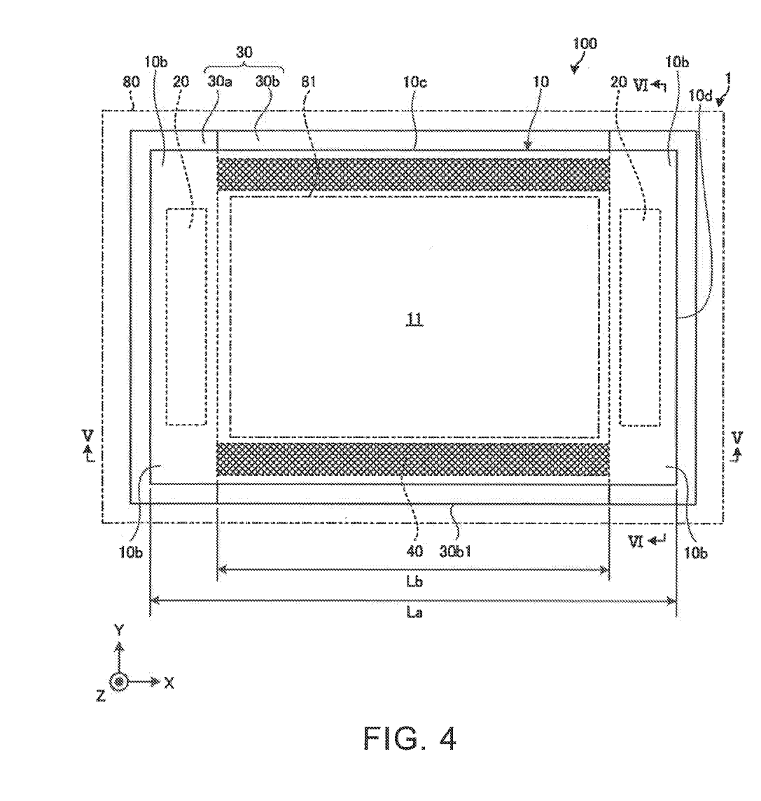

FIG. 1A and FIG. 1B, and the FIG. 4 and the subsequent figures are schematic views. Therefore, the size, shape, and the like of each constituent element shown in FIG. 1A and the like are not necessarily accurate. In each figure, in some cases each constituent element is shown in exaggeration for convenience of understanding. In FIG. 1A and FIG. 1B, a three-dimensional orthogonal coordinate system including an X axis, a Y axis and a Z axis is shown. The three-dimensional orthogonal coordinate system may be represented in other figures.

As shown in FIG. 1A and FIG. 1B, the input device 1 includes an operation panel 10, vibrators 20, a support panel 30, and adhesive portions 40. The input device 1 can be used, for example, as a touch panel having a vibration function in which the operation surface 11 of the operation panel 10 is vibrated by being controlled by a controller (not shown). Further, as described below, the input device 1 and the controller can be used as the touch panel having a vibration function in combination with a display such as a liquid crystal display.

The operation panel 10 is a flat plate member. Specifically, the operation panel 10 is a quadrilateral plate, and more specifically, a rectangular plate having a long side 10c and a short side 10d. The operation panel 10 has an operation surface 11 substantially at the center. The operation panel 10 has a function of detecting a contact position of a user with the operation surface 11. For example, the operation panel 10 includes a capacitive type contact sensor (not shown), and the contact position of the user with the operation suffice 11 can be detected by the contact sensor. When the operation panel 10 does not have the function of detecting the contact position, the support panel 30 may have the function of detecting the contact position, or a configuration having the function of detecting the contact position may be separately disposed. The contact of the user with the operation surface 11 is performed, for example, by the user bring a finger or the like into contact with the operation surface 11, or bring a touch pen or the like into contact with the operation surface 11.

The vibrators 20 are vibration elements, for example, piezoelectric elements (piezo elements) or the like. There is a plurality of 20 (here, two vibrators). In the example shown in FIG. 1A and FIG. 1B, the number of vibrators 20 is two, but it is not limited thereto, and may be one or three or more.

As shown in FIG. 1B, the vibrators 20 are each mounted, for example, on the vicinities of end portions of short sides 10d of the back surface 12 of the operation panel 10 opposite to the operation surface 11. The vibrators 20 are fixedly mounded on the back surface 12 of the operation panel 10 with an adhesive and the like. The two vibrators 20 are mounted to face each other.

In this way, since the vibrators 20 are mounted on the back surface 12 of the operation panel 10, for example, heat generated when the vibrators 20 are vibrated is less likely to be transferred to the operation surface 11, which makes it possible to suppress excessive rise in temperature of the operation surface 11.

Then, the vibrators 20 vibrate the operation panel 10. For example, the vibrators 20 are controlled by the controller, and can vibrate the operation panel 10 in a plurality of modes in which vibration frequencies are different.

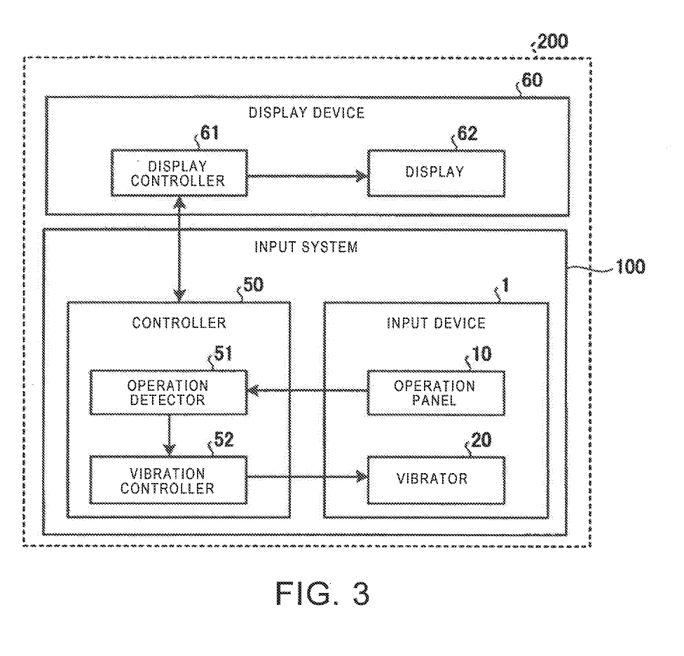

Specifically, the vibrators 20 vibrate the operation panel 10 at a high frequency in an ultrasonic band in a state where the user's finger is in contact with the operation surface 11, or vibrates the operation panel 10 at a frequency lower than the ultrasonic band. In this way, a slippery feel and a tremblingly vibratory feel can be given to the user's finger on the operation surface 11, which will be described later with reference to FIG. 3.

The support panel 30 is disposed to face the back surface 12 of the operation panel 10, and supports the operation panel 10.

The adhesive portion 40 allows the operation panel 10 and the support panel 30 to adhere to each other. The entire surface of the operation panel 10 does not adhere to the support panel 30 with adhesive portions 40, but the operation panel 10 partially adheres to the support panel 30, for example, the long side 10c as shown in FIG. 1A, which will be described later with reference to FIG. 4.

Meanwhile, the vibrators 20 according to the present embodiment are mounted on the back surface 12 of the operation panel 10 as described above. For this reason, in the related art, in some cases it is difficult to draw out a wire that is connected to the vibrator, since the wire comes into contact with the support panel depending on the size of the support panel.

Therefore, in the present embodiment, the support panel 30 includes a plurality (here, two) of support panels of different sizes. This makes it easier to draw out the wires 21 from the vibrators 20.

Specifically, the support panel 30 according to the present embodiment includes a first support panel 30a and a second support panel 30b. In FIG. 1A, in order to dearly show the shape of the second support panel 30b, the second support panel 30b is represented with hatches.

The first and second support panels 30a and 30b are quadrilateral plates, and in detail rectangular plates, which are similar with the operation panel 10. As shown in FIG. 1A, the first support panel 30a is formed such that, when seen from the operation surface 11, each side of the first await panel 30 is longer than the long side 10c and the short side 10d of the operation panel 10, that is, in a plan view, the area of the fast support panel 30a is larger than that of the operation panel 10.

In this way, the first support panel 30a is formed in a shape to include the mounting region on which the vibrators 20 of the operation panel 10 is mounted when seen from the operation surface 11 (that is, when seen in the negative dire ion of the Z axis). In other words, the first support panel 30a is shaped so as to overlap the mounting regions of the vibrators 20 in the operation panel 10 when seen from the operation surface 11. The mounting region is the same region as that surrounded by the outlines of the vibrators 20 indicated by broke lines in FIG. 1A.

As shown in FIG. 1B, the second support panel 30b is disposed between the operation panel 10 and the first support panel 30a. As shown in FIG. 1A, the second support panel 301) is formed to be positioned inside the mounting regions of the vibrators 20 in the operation panel 10 when seen from the operation surface 11. In other words, when seen from the operation surface 11, the second support panel 30b is positioned between vibrators 20 facing each other, and shaped so as not to overlap the mounting regions of the vibrators 20 in the operation panel 10.

Since the second support panel 30b is shaped as described above, spaces B are formed between the operation panel 10 and the first support panel 30a, and in the vicinities of the vibrators 20 (see FIG. 1B). Therefore, in the present embodiment, the wires 21 connected to vibrators 20 can be easily drawn out from the vibrators 20 using the spaces B without coming into Contact with the first support panel 30a and the like.

Further, in the present embodiment, it is possible to suppress excessive deformation of the operation panel 10. That is, for example, as indicated by an arrow F in FIG. 1B, the end portion of the short side 10d of the operation panel 10 may be strongly pressed by the user. In this case, since the spaces B are formed on the side of the back surface 12 of the operation panel 10, the operation panel 10 is bent in the negative direction of the Z axis. However, in the present embodiment, since the first support panel 30a is positioned on the side of the negative direction of the Z axis of the operation panel 10, the operation panel 10 is brought into contact with the first support panel 30a. That is, the first support panel 30a functions as a stopper that inhibits the operation panel 10 from being displaced in the negative direction of the Z axis, which makes it possible to suppress excessive deformation of the operation panel 10.

### 2. Example of Mounting of Electronic Device System

FIG. 2 is a view showing an example of mounting of an electronic device system 200 including an input system 100 provided with the input device 1 according to the embodiment. As shown in FIG. 2, the electronic device system 200 according to the present embodiment is mounted on a vehicle as one example.

The electronic device system 200 includes the input system 100 and a display device 60. The input system 100 is connected in-vehicle devices, such as the display device 60 or a speaker, for example, through network communication, and functions as an input device of the in-vehicle devices. In addition, the input system 100 includes the input device 1, and the input device 1 can be used as the touch pad as described above.

The operation surface 11 of the operation panel 10 is disposed at a position where a driver can operate it easily, for example, in the vicinity of a shift lever S of a center console. In the example of FIG. 2, the operation surface 11 is disposed between an arm lever R and the shift lever S. Therefore, the user can operate the operation surface 11 with the arm of the user placed on the arm lever R. In this way, the user can easily operate the input system 100 without rearranging the user's driving posture.

Examples of the in-vehicle device include various devices, such as the display device 60 for displaying a predetermined image, a speaker for outputting predetermined sound, an air conditioner, a car navigation system and the like. Therefore, the user can operate such various devices by operating the input system 100.

When an input operation from the user is accepted, the above-described input system 100 generates high frequency vibration and low frequency vibration on the operation panel 10 in accordance with the input operation, thereby allowing the user to recognize the acceptance of the input operation.

### 3. Details of Electronic Device System

Next, the electronic device system 200 according to the embodiment will be described using FIG. 3. FIG. 3 is a view showing an example of a configuration of the electronic device system 200 according to the embodiment. In FIG. 3, only constituent elements necessary for describing the features of the present embodiment is shown as functional blocks, and descriptions of general constituent elements will be omitted.

In other words, each constituent element shown in FIG. 3 is functionally conceptual, and does not necessarily need to be physically configured as shown. For example, specific forms of distribution and integration of each functional block are not limited to the forms shown in the drawings, and can be configured by physically or functionally distributing and integrating all or a part of the firms in arbitrary units according to various loads and usage situations.

As shown in FIG. 3, the electronic device system 200 includes the input system 100 and the display device 60. The input system 100 includes the input device 1 and the controller 50. The input device 1 accepts the input operation from the user. The input device 1 includes the operation panel 10 and the vibrator 20 described above. When an input performed by the user is accepted through the operation surface 11, the operation panel 10 detects a contact position of the user with the operation surface 11 and outputs a signal including information corresponding to the detected contact position (for example, coordinate information) to the controller 50.

The controller 50 controls the vibrator 20 according to the detected contact position by the operation panel 10 of the input device 1. The controller 50 is a microprocessor including a central processing unit (CPU), a storage, and the like.

The controller 50 includes an operation detector 51 and a vibration controller 52. The operation detector 51 detects the input operation which the user performs on the operation surface 11 based on the information of the contact position output from the operation panel 10.

For example, when the electronic device system 200 is used as a car navigation system, if the information of the contact position output from the operation panel 10 is the position corresponding to a destination setting button on the operation surface 11, the operation detector 51 detects that an input operation by the user is an input operation to set the destination.

When the input operation performed by the user on the operation surface 11 is detected, the operation detector 51 outputs a signal indicating the detected input operation to the vibration controller 52 and the display device 60.

The vibration controller 52 outputs a voltage signal to the vibrator 20 based on a signal output from the operation detector 51, that is the signal indicating the input operation of the user to control the vibrator 20. That is, the vibration controller 52 controls the vibrator 20 based on the input operation on the operation surface 11.

Specifically, the vibration controller 52 can control the vibrator 20 so as to vibrate the operation panel 10 in a plurality of modes in which the vibration frequencies are different, based on the input operation on the operation surface 11. More specifically, the vibration controller 52 can control the vibrator 20 so as to switch between the mode in which the vibration of the frequency in the ultrasonic band is generated on the operation panel 10 and the mode in which the vibration in the frequency band lower than the ultrasonic band is generated on the operation panel 10 based on the input operation on the operation surface 11.

The frequency in the ultrasonic band described above (high frequency) is, for example, 20 to 40 kHz, and the frequency lower than the ultrasonic band (low frequency) is, for example, 200 Hz or less, but the frequencies are not limited thereto. The mode in which vibration is generated at the high frequency in the ultrasonic band is one example of a first vibration mode. The mode in which vibration is generated at the low frequency is one example of a second vibration mode.

When the vibration controller 52 controls the vibrator 20 to vibrate the operation panel 10 at the high frequency in the ultrasonic band, the standing wave W is generated on the operation panel 10, thereby making it possible to reduce the fictional force of the operation surface 11 with respect to the user using the squeeze effect.

The squeeze effect ran to a phenomenon that, when the standing wave W is generated by vibrating the operation surface 11 at a high frequency by the vibrator 20, an air layer is formed between the user's finger and the operation surface 11 due to pressure fluctuation by vibration, and thus the frictional resistance between the user's finger and the operation surface 11 becomes relatively low compared with when there is no vibration.

From the fact that the frictional force on the operation surface 11 of the operation panel 10 is reduced, for example, it is possible to give the user a smooth tactile sensation as if the user is sucked in the sliding direction of the sliding operation of the user moving the finger on the operation surface 11 of the operation panel 10.

Further, when the vibration controller 52 controls the vibrator 20 to vibrate the operation panel 10 at a low frequency in a state in which the user's finger is in contact with the operation surface 11, it is possible to give the user a trembling tactile sensation by transferring the vibration of the vibrator 20 to the user's finger through the operation panel 10.

The display device 60 includes a display controller 61 and a display 62. The display controller 61 displays a predetermined image on the display 62 in response to a signal output from the operation detector 51 and indicating the input operation of the user on the operation surface 11. The display 62 can use, for example, a liquid crystal display, but is not limited thereto and may use other types of displays such as an organic EL display or the like.

### 4. Specific Configuration of Input System

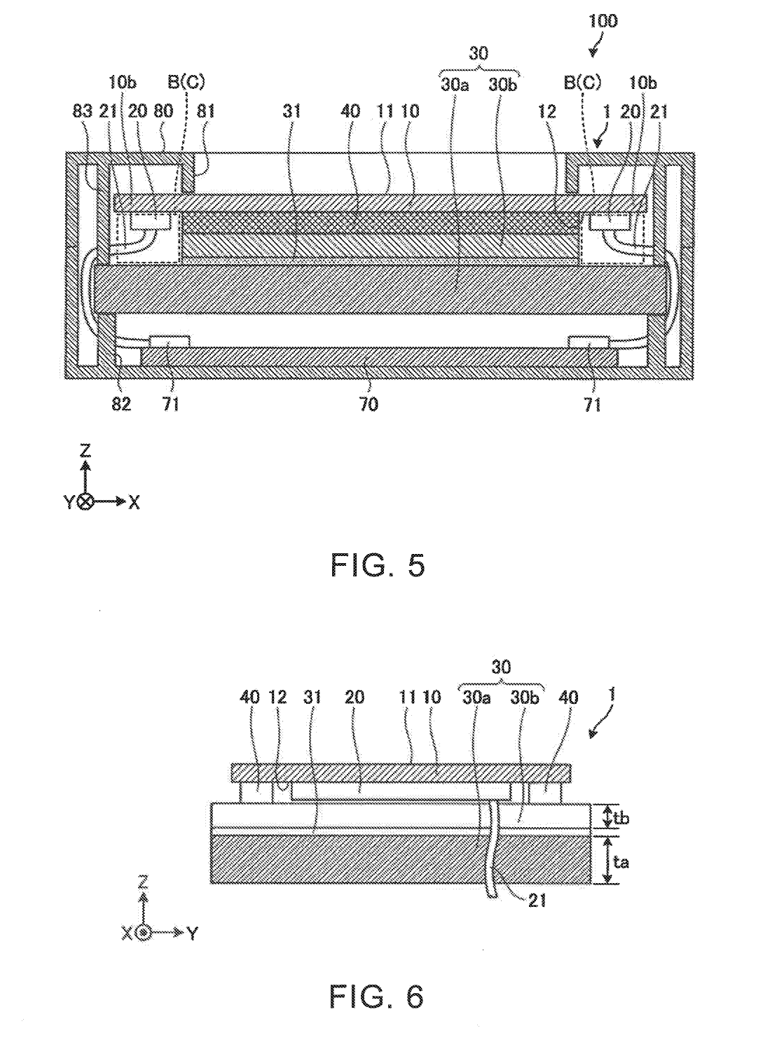

Next the input system 100 including the input device 1 will be described in detail with reference to FIG. 4 and FIG. 5. FIG. 4 is a plan view of the input system 100 according to the embodiment, and FIG. 5 is a cross sectional view taken along line V-V of FIG. 4.

The input system 100 includes the input device 1 described above, a control board 70 on which the controller 50 is mounted (see FIG. 5), and a housing 80. On the control board 70, connection terminals 71 (see FIG. 5) for the controller 50 are mounted in addition to the controller 50 and the like described above. The connection terminal 71 is electrically connected to the vibrator 20 through the wire 21.

The housing 80 is formed, for example in a substantially rectangular parallelepiped shape, and accommodates the input device 1, the control board 70, and the like. In FIG. 4, in order to better show the input device 1 and the like accommodated in the housing 80, the housing 80 is drawn by imaginary lines.

An opening 81 having a substantially rectangular shape in a plan view is formed in the housing 80. The operation panel 10 is disposed close to the opening 81 of the housing 80, and a portion of the operation panel 10 that is exposed through the opening 81 is the operation surface 11.

As shown in FIG. 5, the housing 80 includes a placing portion 82 and a pressing portion 83. The placing portion 82 protrudes upward from the bottom surface of the housing 80 to place the support panel 30. The pressing portion 83 protrudes downward from the top surface of the housing 80. Then, the pressing portion 83 presses the support panel 30 toward the placing portion 82. In this way, the input device 1 including the support panel 30 is stably held in the housing 80. The positions and shapes of the placing portion 82 and the pressing portion 83 shown in FIG. 5 are merely examples, and are not limited.

As shown in FIG. 4, the vibrators 20 of the input device 1 are mounted on the end portions of the long side direction (X axis direction) of the operation panel 10, respectively, but it is not limited thereto. For example, the vibrators 20 may be Mounted on the end portions of the short side direction (Y axis direction) of the operation panel 10. The vibrators 20 are mounted, for example, facing with each other in the region outside the operation surge 11.

The operation panel 10, the first support panel 30a, and the second support panel 30b have the rectangular shape in a plan view as described above. The second support panel 30b is formed such that the side 30b1 corresponding to the long side 10c of the operation panel 10 is shorter than the long side 10c of the operation panel 10. That is, the length Lb of the side 30b1 of the second support panel 30b is set to be shorter than the length La of the long side 10c of the operation panel 10 (Lb<La).

In this way, in the present embodiment, vibrators 20 are mounted on the end portions in the long side direction of the operation panel 10 and the length Lb of the side 30b1 of the second support pane1 30b is set as described above. In this way, the spaces B can be reliably formed between the operation panel 10 and the first support panel 30a and in the vicinities of the vibrators 20 (see FIG. 5), which makes it possible to draw out the wires 21 from the vibratos 20 more easily.

FIG. 6 is a (loss sectional view taken along line VI-VI in FIG. 4. In FIG. 6, for simplicity of the figure, illustration of the housing 80 is omitted. As shown in FIG. 6, the second support panel 30b is formed such that the thickness tb of the second support panel 30b is smaller than the thickness ta of the first await panel 30a (tb<ta).

Since the thickness tb of the second support panel 30b is set as described above, it is possible to suppress increase in height of the whole input device 1 in the Z axis direction while securing the spaces B having a height enough to draw out the wires 21 from the vibrators 20 (see FIG. 5).

The first support panel 30a and the second support panel 30b adhere to each other by the support panel adhesive portion 31. In this way, even when the support panel 30 is constituted by a plurality of members of the first support panel 30a and the second support panel 30b, it is possible to easily integrate the first support panel 30a and the second support panel 30b with each other. As the support panel adhesive portion 31, for example, an optical adhesive tape and the like having transparency can be used, but it is not limited thereto.

The operation panel 10 and the first and second support panels 30a and 30b are all made of glass having relatively high hardness. In this way, durability of the operation panel 10 and the first and second support panels 30a and 30b against, for example, impact or heat from the outside can be improved. The operation panel 10 and the first and second support panels 30a and 30b are not limited to being made of glass, and may be made of other kinds of materials, such as a resin, for example.

As shown in FIG. 5, spaces C are formed between four corners 10b in the operation panel 10 and the first support panel 30a. In FIG. 5, the spaces C and the spaces B for the wires 21 described above overlap each other. In this way, since the spaces C are present on the side of the back surface 12 of the operation panel 10 at the regions corresponding to the four corners 10b, the operation panel 10 is easily swayed relative to the support panel 30, and is in a so-called floating state.

In this way, for example, when the vibrator 20 is vibrated at a high frequency, the input device 1 can effectively generate low frequency vibration on the operation panel 10 with the vibration of the vibrator 20. In the present embodiment, the space C is formed between all of four corners 10b in the operation panel 10 and the first support panel 30a, but it is not limited thereto, and the space C may be formed between a part of the four corners 10b and the first support panel 30a.

As shown in FIG. 4, the adhesive portion 40 is positioned, for example, on the region outside of the operation surface 11. In FIG. 4, in order to clearly show the positions at which the adhesive portions 40 are provided, the adhesive portions 40 are indicated by shading.

The adhesive portions 40 are provided at positions where the long sides 10c of the operation panel 10 and the second support panel 30b adhere to each other. In this way, it is possible to effectively generate high frequency vibration and low frequency vibration on the operation panel 10.

That is, when the operation panel 10 is bent due to vibration of the operation panel 10, generation of high frequency vibration, or the like on the operation panel 10 is hindered. Therefore, in the present embodiment, since the long sides 10c of the operation panel 10 that is likely to be bent and the second support panel 30b adhere to each other by the adhesive portions 40, it is possible to suppress the bending, which makes it possible to effectively generate high frequency vibration and low frequency vibration on the operation panel 10.

As the adhesive portion 40, for example, an adhesive tape (double-sided tape) with an acrylic base material can be used, but it is not limited thereto.

As described above, the input device 1 according to the embodiment includes the operation panel 10, the vibrators 20, and the support panel 30. The operation panel 10 has the operation surface 11. The vibrators 20 ate mounted on the end portions of the back surfaces 12 of the operation panel 10 opposite to the operation surface 11, and vibrate the operation panel 10. The support panel 30 is disposed to face the back surface 12 of the operation panel 10, and supports the operation panel 10.

The support panel 30 includes the first support panel 30a and the second support panel 30b. The first support panel 30a is formed in a shape to include the mounting regions on which the vibrators 20 of the operation panel 10 are mounted when seen from the operation surface 11. The second support panel 30b is disposed between the operation panel 10 and the first support panel 30a, and when seen from the operation surface 11, is formed to be positioned inside the mounting regions of the vibrators 20 on the operation panel 10. In this way, the wires 21 can be easily drawn out from the vibrators 20 that are mounted on the back surface 12 of the operation panel 10.

The wires 21 connected to the vibrators 20 are disposal in the space B between the operation panel 10 and the first support panel 30a. In this way, the wires 21 can be more easily drawn out from the vibrators 20.

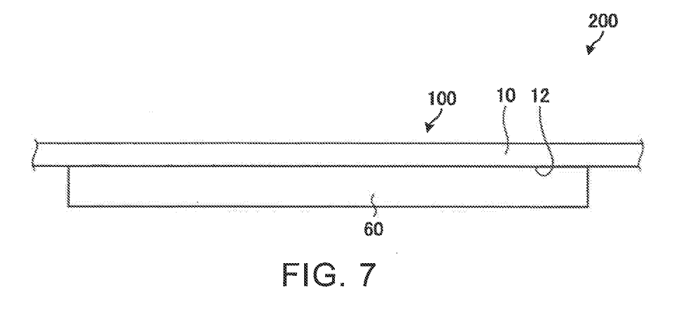

In the electronic device system 200 described above, the input system 100 and the display device 60 are separately disposed (see FIG. 2), but it is not limited thereto. That is, as shown in FIG. 7, the electronic device system 200 may be configured to include a touch panel in which the input system 100 and a display device 60 are integrated.

FIG. 7 is a view showing a relationship between the input system 100 in the electronic device system 200 and a display device 60. As shown in FIG. 7, the display device 60 is disposed on the back surface 12 of the operation panel 10, and the user con view the screen displayed on the display device 60 through the operation panel 10. In FIG. 7, illustration of the support panel 30 and the like is omitted.

In the above, the adhesive tape used as the adhesive portion 40 and the support panel adhesive portion 31 has been specifically shown, but it is merely an example and the portions are not limited to the adhesive tape. The adhesive tape is used as the adhesive portion 40 and the support panel adhesive portion 31, but the portions are not limited to the adhesive tape and an adhesive or the like may be used.

In the above description, an example in which the electronic device system 200 is mounted on a vehicle is represented, but it is not limited thereto. For example, the electronic device system 200 may be mounted on other types of devices such as a smartphone terminal or a tablet terminal.

Further effects and modified examples can be easily derived by those skilled in the art. Thus, broader aspects of the present invention are not limited to the specific details and the representative embodiment shown and described above. Accordingly, various modifications can be made without departing from the scope and spirit of the general inventive concept as defined by appended claims and equivalents thereof.

What is claimed is:

1. An input device comprising:
an operation panel that has an operation surface and a back surface facing in a direction opposite to a direction in which the operation surface faces;
a vibrator that is mounted on a mounting region of the operation panel located at an end portion of the back surface of the operation panel and vibrates the operation panel; and
a support panel that is disposed to face the back surface of the operation panel and supports the operation panel,
wherein the support panel includes
a first support panel that, when viewed in a direction orthogonal to the operation surface, overlaps the mounting region of the operation panel on which the vibrator is mounted, and
a second support panel that is disposed between the operation panel and the first support panel, and, when viewed in the direction orthogonal to the operation surface, does not overlap the mounting region of the operation panel on which the vibrator is mounted.

2. The input device according to claim 1, wherein
the operation panel is a rectangular plate having opposite long sides and opposite short shorter than the long sides,
the second support panel is a quadrilateral plate,
the vibrator is mounted on an end portion of at least one of the opposite short sides of the operation panel, and sides of the second support panel corresponding to the long sides of the operation panel are shorter than the long sides of the operation panel.

3. The input device according to claim 1,
wherein a thickness of the second support panel is less than a thickness of the first support panel.

4. The input device according to claim 1,
wherein the operation panel is a glass plate.

5. The input device according to claim 1, further comprising:
a wire that is connected to the vibrator and is disposed in a space between the operation panel and the first support panel,

6. The input device according to claim 1,
wherein the operation panel is a quadrilateral plate, and a space is formed between some or all of four corners of the operation panel and the first support panel.

7. The input device according to claim 1, further comprising:
an adhesive portion that adheres the first support panel and the second support panel to each other.

8. An input system comprising:
an input device that includes an operation panel that has an operation surface and a back surface facing in a direction opposite to a direction in which the operation surface faces, a vibrator that is mounted on a mounting region of the operation panel located at an end portion of the back surface of the operation panel and vibrates the operation panel, and a support panel that is disposed to face the back surface of the operation panel and supports the operation panel, the support panel including a first support panel that, when viewed in a direction orthogonal to the operation surface, overlaps the mounting region of the operation panel on which the vibrator is mounted, and a second support panel that is disposed between the operation panel and the first support panel, and when viewed in the direction orthogonal to the operation surface, does not overlap the mounting region of the operation panel on which the vibrator is mounted; and
a vibration controller that controls the vibrator based on an operation on the operation surface.

9. The input system according to claim 8,
wherein the vibration controller controls the vibrator so as to switch between a first vibration mode in which vibration of a frequency of an ultrasonic band is generated on the operation panel and a second vibration mode in which vibration of a frequency band lower than the ultrasonic band is generated on the operation panel, based on the operation on the operation surface.

10. The input system according to claim 8, wherein
the operation panel is a plate having opposite long sides and opposite short sides that are shorter than the long sides,
the second support panel is a quadrilateral plate,
the vibrator is mounted on an end portion of at least one of the opposite short sides of the operation panel, and
sides of the second support panel corresponding to the long sides of the operation panel are shorter than the long sides of the operation panel.

11. The input system according to claim 8,
wherein a thickness of the second support panel is less than a thickness of the first support panel.

12. The input system according to claim 8,
wherein the operation panel is a glass plate.

13. The input system according to claim 8 further comprising:
a wire that is connected to the vibrator and is disposed in a space between the operation panel and the first support panel.

14. The input system according to claim 8,
wherein the operation panel is a quadrilateral plate, and a space is formed between some or all of four corners of the operation panel and the first support panel.

15. The input system according to claim 8, further comprising:
an adhesive portion that adheres the first support panel and the second support panel to each other.
